(19) United States
(12) Patent Application Publication
(10) Pub. No.: US 2010/0179237 A1
(43) Pub. Date: Jul. 15, 2010

(54) THERMOPLASTIC FOAM BLOWING AGENT COMBINATION

(75) Inventors: Christopher A. Bertelo, Doylestown, PA (US); Brett L. Van Horn, Mont Clare, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 12/305,761

(22) PCT Filed: Jun. 20, 2007
(86) PCT No.: PCT/US07/71615

§ 371 Date: Dec. 19, 2008

Related U.S. Application Data
(60) Provisional application No. 60/815,338, filed on Jun. 21, 2006.

(51) Int. Cl. C08J 9/00; C09K 3/00

(52) U.S. Cl. 521/82; 252/182.15

(57) ABSTRACT

A blowing agent for thermoplastic foams such as extruded polystyrene foam is disclosed. The blowing agent is a blend of a low solubility blowing agent, such as 1,1,1,2-tetrafluoroethane, and a dichloroethylene such as trans-1,2-dichloroethylene. The blowing agent combination enhances processability of thermoplastic foam.

### FIELD OF THE INVENTION

The present invention relates to blowing agents for thermoplastic foams such as extruded polystyrene foam. More particularly, the present invention relates to the use of trans-1,2-dichloroethylene as an additive for blowing agents in the manufacture of thermoplastic foams.

### BACKGROUND OF THE INVENTION

High boiling, volatile liquids, such as ketones, alcohols, ethers, or high boiling HFC's can be used as co-blowing agents in the production of thermoplastic foams. By themselves, the high boiling liquids, such as isopropanol or 2-ethyl hexanol, are not be very good blowing agents, lacking sufficient blowing power to produce low density foam. However, they can be blended with higher volatility blowing agents for the purposes of cost reduction, tailoring the blowing power of the blend, improving the solubility of the blowing agent, or increasing product performance.

Trans-1,2-dichloroethylene (TDCE) has been used in the production of foamed products, however prior uses of TDCE relate to the production of polyurethane or polyisocyanurate foams. For instance, U.S. Pat. Nos. 6,793,845 and 6,348,515 and US Patent Application Number 2004/0132632 disclose the use of TDCE in pentane-based blowing agents in polyols to improve the processability, cold temperature k-factor, or fire performance of polyurethane foams. Other patents, including U.S. Pat. Nos. 6,896,823 and 6,790,820, disclose the use of TDCE in polyol premix compositions containing HFC-245fa (1,1,1,3,3-pentafluoropropane), for the purpose of providing compositions with relatively constant boiling points and/or vapor pressures.

### SUMMARY OF THE INVENTION

It has been discovered that TDCE can improve the processability when foaming thermoplastics with blowing agents, particularly hydrofluorocarbons (HFC's) such as HFC-134a (1,1,1,2-tetrafluoroethane). HFC's, being non-ozone depleting compounds, have been identified as alternative blowing agents to chlorofluorocarbons (CFC's) and hydrochlorofluorocarbons (HCFC's) in the production of thermoplastic foams. However, it has been found that it can be more difficult to process thermoplastic foams with many HFC's than with CFC's or HCFC's. For instance in the production of extruded polystyrene (XPS) foam, HFC-134a and HFC-125 (pentafluoroethane) have limited solubility and higher degassing pressure in the polystyrene resin than HCFC-142b (1-chloro-1,1-difluoroethane). This makes them more prone to premature degassing and makes it more difficult to control the foaming process when using these lower solubility HFC's. The use of such HFC's can require a higher operating pressure which may not be acceptable in many extrusion systems.

It was found that adding a small amount TDCE to a foamable thermoplastic composition being blown with low solubility blowing agent can improve the processability by decreasing the required operating pressure and limiting the premature degassing. This results in better control of the foaming process in the production of thermoplastic foams, such as open-cell or closed-cell styrenic insulating foams. Furthermore, adding TDCE can improve the solubility of the blowing agent in the resin mix, allowing for more blowing agent to be added. This allows for lower density, closed-cell foam to be produced than when the blowing agent is used without TDCE. Increasing the blowing agent loading, like HFC-134a, by increasing the solubility in the resin can result in improvement in the insulating performance of the closed-cell foam.

### DETAILED DESCRIPTION OF THE INVENTION

HFC's, being non-ozone depleting compounds, have been identified as alternative blowing agents to chlorofluorocarbons (CFC's) and hydrochlorofluorocarbons (HCFC's) in the production of thermoplastic foams. However, it's been found that it can be more difficult to process thermoplastic foams being blown with many HFC's than with CFC's or HCFC's. For instance in the production of extruded polystyrene (XPS) foam, HFC-134a and HFC-125 (pentafluoroethane) have limited solubility and higher degassing pressure in the thermoplastic resin than either CFC-12 (dichlorodifluoromethane) or HCFC-142b (1-chloro-1,1-difluoroethane). This requires foam extrusion systems to be operated at a higher pressure to keep the blowing agent in solution and prevent premature degassing before the die. The higher degassing pressure makes the foaming more difficult to control and the higher operating pressure may be too high for some extrusion systems. The present invention comprises adding an amount of TDCE to a thermoplastic blowing system using a low solubility blowing agent, such as HFC-134a or carbon dioxide, sufficient to decrease the required operating pressure, to increase the processability with the low solubility blowing agent and/or to increase the amount of blowing agent that can be used in order to produce lower density foam.

Exemplary blowing agents in the production of closed-cell foam in accordance with the present invention include hydrofluorocarbons such as difluoromethane (HFC-32), perfluoromethane, 1,1-difluoroethane (HFC-152a), 1,1,1-trifluoroethane (HFC-143a), 1,1,2-trifluoroethane (HFC-143), 1,1,2,2-tetrafluoroethane (HFC-134), 1,1,1,2-tetrafluoroethane (HFC-134a), pentafluoroethane (HFC-125), perfluoroethane, 1,1,1,3,3-pentafluoropropane (HFC-245fa), 1,1,1-trifluoropropane (HFC-263fb), and 1,1,1,2,3,3,3-heptafluoropropane (HFC-227ea); inorganic gases such as argon, nitrogen, and air; carbon dioxide; organic blowing agents such as hydrocarbons having from one to nine carbons including methane, ethane, propane, n-butane, isobutane, n-pentane, isopentane, neopentane, cyclobutane, and cyclopentane. Preferred blowing agents of the present invention include HFC-134a, HFC-32, HFC-125, HFC-152a, HFC-143a, carbon dioxide, and mixtures thereof.

The present invention includes blowing agent compositions comprising TDCE for use in the production of thermoplastic foams, particularly blowing agent compositions comprising a low solubility blowing agent like HFC-134a in polystyrene. The TDCE is added to the low solubility blowing agent in an amount sufficient to improve the processability or product performance of the blowing agent. The blowing agent compositions of the present invention preferably contain less than about 20 wt % TDCE, more preferably less than about 10 wt % TDCE.

The blowing agent combination of the present invention can be employed in the production of either closed-cell foam or open-cell foam. A foam having a open cell content of about 25% or less, preferably about 15% or less and most preferably about 10% or less is considered a closed-cell foam. Foam having an open cell content of about 20% or more, preferably about 50% or more, more preferably about 60% or more and most preferably about 70% or more is considered open-cell foam. Open-cell foams see use in insulating systems such as those using vacuum panel technology. Closed-cell foams also see use in insulating technologies. However, the closed-cell structure is not suitable for use in vacuum panel technology due to the difficulty of evacuating the entrapped gas. It was discovered that the blowing agent combination of the present invention exhibits enhanced properties in both open-cell and closed-cell extruded thermoplastic foam applications.

Controlling the open cell content of thermoplastic foams is important whether the intent is to produce closed cell foams, open cell foams, or foam with intermediate open cell content. Foaming of thermoplastic resins has a wide range of uses including cost reduction, thermal insulation, sound dampening (acoustical foams), filtering, cushioning, and floatation, just to name a few. Though many thermal insulating foams are closed-cell foams, open cell foams can also be useful in thermal insulating applications such as in vacuum insulating panels or some roofing insulation requiring a high heat distortion temperature. Open cell foams used as filtering media also need to have significant open cell content.

A challenge is to produce thermoplastic foams, such of polystyrene, with consistent and elevated open cell content. A means of producing the open cell thermoplastic foams is by foaming at elevated temperatures. A disadvantage of this technique is that the temperature must be high enough to generate the open cells but low enough to prevent foam collapse, so the resulting operating temperature range may be very narrow. The foam collapse will result in foams with higher density, small cross section, and generally poor skin quality.

Another means of producing open cell thermoplastic foam is to employ loadings of dissimilar, nonmiscible polymer into the resin. The dissimilar, nonmiscible polymers help to open cells by forming domains in the walls of expanding cells. The domains increase the likelihood of pores developing in the cell walls. Disadvantages of this include are that the excessive amounts of dissimilar, nonmiscible polymer employed can greatly increase the cost of the process and can significantly impact the physical properties of the resulting foam products. Even low loadings (i.e. <2 wt %) of dissimilar polymers into the base thermoplastic resin can significantly alter the resulting physical properties.

In this invention it was discovered that trans-1,2-dichloroethylene (TDCE) can be used to help control the open cell content of a thermoplastic foam, particularly polystyrene foam. Employing low to moderate levels of TDCE into the foamable resin composition can permit production of foam with controllable open cell content, from low to high percent open cell. Foams of the present invention have an open cell content of greater than about 10%, preferably greater than about 05%, more preferably greater than about 50%, and even more preferably greater than about 70%. Blowing agent compositions, based upon total blowing agent, of the present invention contain between about 5 wt % and about 95 wt % TDCE, preferably between about 10 wt % and 75 wt % TDCE, and more preferably between about 15 wt % and 50 wt % TDCE. The composition range may alternatively be presented in terms of wt % with respect to total resin instead of with respect to total blowing agent.

In the present invention, in the production of open-cell foam, TDCE will be used in combination with other blowing agents. Common blowing agents include HCFC's (hydrochlorofluorocarbons), including HCFC-142b (1-chloro-1,1-difluoroethane) and HCFC-22 (chloro-difluoromethane), HFC's (hydrofluorocarbons), including HFC-134a (1,1,1,2-tetrafluoroethane), HFC-152a (1,1-difluoroethane), HFC-32 (difluoromethane), HFC-143a (1,1,1-trifluoroethane), HFC-125 (pentafluoroethane), alkanes, including n-pentane, iso-pentane, cyclopentane, n-butane, iso-butane, and hexane, carbon dioxide, nitrogen, and mixtures thereof.

Blowing agents used with TDCE in the present invention can be added by any suitable means and may be physical blowing agents, which are generally added under pressure and dissolved into the resin prior to expansion, or chemical blowing agents which decompose during processing to generate the blowing agent gases, such as carbon dioxide and/or nitrogen.

Foam preparation processes of the present invention include batch, semi-batch, and continuous processes. Batch processes involve preparation of at least one portion of the foamable polymer composition in a storable state and then using that portion of foamable polymer composition at some future point in time to prepare a foam. For instance, in the production of some EPS (expanded polystyrene) foams the manufacturing process takes several steps. The polystyrene particle granules are pre-expanded by free exposure to steam which produces closed cell non-interconnecting beads.

After the pre-expansion, the beads still contain small quantities of both condensed steam and pentane gas and are allowed to cool in large silos where the air gradually diffuses into the pores, replacing in part the two expansion components of steam and pentane gas.

The beads are allowed to age and go through this diffusing process after which the beads are molded to form blocks or customized formed products. The mould serves to shape and retain the beads in a pre-form shape and then steam is once again applied to promote additional expansion. During this application of the steam and pressure causes the fusion of each bead to its neighboring beads, resulting in a homogenous end product.

Once the product is allowed to cool for a short time, the product is removed from the mould for further conditioning or cut into various shaped by use of hot wire devices or other appropriate techniques.

A semi-batch process involves preparing at least a portion of a foamable polymer composition and intermittently expanding that foamable polymer composition into a foam all in a single process. For example, U.S. Pat. No. 4,323,528, herein incorporated by reference, discloses a process for making polyolefin foams via an accumulating extrusion process. The process comprises: 1) mixing a thermoplastic material and a blowing agent composition to form a foamable polymer composition; 2) extruding the foamable polymer composition into a holding zone maintained at a temperature and pressure which does not allow the foamable polymer composition to foam; the holding zone has a die defining an orifice opening into a zone of lower pressure at which the foamable polymer composition foams and an openable gate closing the die orifice; 3) periodically opening the gate while substantially concurrently applying mechanical pressure by means of a movable ram on the foamable polymer composition to eject it from the holding zone through the die orifice into the zone of lower pressure, and 4) allowing the ejected foamable polymer composition to expand to form the foam.

A continuous process involves forming a foamable polymer composition and then expanding that foamable polymer composition in a non-stop manner. For example, prepare a foamable polymer composition in an extruder by heating a polymer resin to form a molten resin, blending into the molten resin a blowing agent composition at an initial pressure to form a foamable polymer composition, and then extruding that foamable polymer composition through a die into a zone at a foaming pressure and allowing the foamable polymer composition to expand into a foam. Desirably, cool the foamable polymer composition after addition of the blowing agent and prior to extruding through the die in order to optimize foam properties. Cool the foamable polymer composition, for example, with heat exchangers.

Foams of the present invention can be of any form imaginable including sheet, plank, rod, tube, beads, or any combination thereof. Included in the present invention are laminate foams that comprise multiple distinguishable longitudinal foam members that are bound to one another.

### EXAMPLES

Inverse Gase Chromatography (IGC) was used to measure the solubility of HFC-134a, HFC-134 (1,1,2,2-tetrafluoroethane), HFC-32 (difluoromethane), HFC-152a (1,1-difluoroethane), HFC-125, HCFC-142b, and TDCE in polystyrene. An IGC capillary column was prepared using general purpose polystyrene. Numerical regression of the retention profiles for the solvents in the polystyrene column showed that TDCE was a suitable solvent for polystyrene, making it a candidate as coblowing agent or co-solvent for polystyrene foaming. The ranking of the solubility in polystyrene for these gases/solvents was TDCE>HCFC-142b>HFC-152a >HFC-32>HFC-134>HFC-134a >HFC-125.

The miscibility of TDCE and HFC-134a was tested by preparing several mixtures of the two components at different compositions, from 0% to 100% TDCE, and checking for phase separation. The two components were found to be miscible.

Extrusion experiments were conducted using a counter-rotating twin-screw extruder with internal barrel diameters of 27 mm and barrel length of 40 diameters. The extruder was equipped with a gear pump between the extruder exit and the shaping die to control the extruder barrel pressure. A general purpose polystyrene resin was used for experiments, during which the resin was continuously fed to the extruder. Blowing agents were continuously injected in the polymer resin melt using high pressure delivery pumps. In the extruder, the blowing agent is mixed and dissolved in the resin melt to produce an expandable resin composition. In the extruder the expandable resin composition is cooled to an appropriate foaming temperature and then extruded from the die where the drop in pressure initiates foaming.

The pressure in the extruder barrel was controlled with the gear pump and was set high enough such that the blowing agent dissolved in the extruder, generally greater than 1000 psig. The die pressure, or discharge pressure, is a function of the feed rate, die geometry, and the viscosity of the expandable resin composition. Insufficient pressure will result in undissolved blowing agent leaving the die, which causes blow holes in the foam, skin defects, unstable foaming, or venting of blowing agent from the die.

The degassing pressure was not directly measured but was indirectly determined by observing the discharge pressure of the gear pump needed to prevent premature degassing; this discharge pressure is also considered the extruder operating pressure.

### Comparative Examples 1 and 2

The extruder was equipped with a shaping strand die with a 2 mm die opening and 1 mm land length. For Comparative Example 1, foams were produced using HCFC-142b at 11 wt % in the polystyrene resin. For Comparative Example 2, foams were produced using HFC-134a as the only blowing agent at 6.8 wt % HFC-134a in the polystyrene resin. Using HCFC-142b required operating pressures >400 psig to prevent premature degassing. Using HFC-134a required operating pressures >800 psig to prevent premature degassing.

### Example 3

The extruder was setup and operated according to Comparative Examples 1 and 2. Foams were produced using a blowing agent composition of 25 wt % TDCE and 75 wt % HFC-134a at loadings of up to 9 wt % total blowing agent in polystyrene resin. The required extruder operating pressure to achieve dissolution of the blowing agent and prevent premature degassing was significantly lower than with 100% HFC-134a as the blowing agent, and was between 400 psig and 800 psig. With the fixed geometry of the shaping die it was difficult to determine the required operating pressure. Examples 4, 5, and 6 were performed with an adjustable geometry die.

Using 25 wt % TDCE in HFC-134a closed-cell foam (about 10% open cell or less) with a density of 4.4 pcf was produced. A foam with an open-cell content of 10% or less can be considered as essentially closed-cell.

### Examples 4, 5, and 6

The strand die used in Examples 1-3 was replaced with an adjustable-lip slot die with a gap width of 6.35 mm. The gap height was adjusted using pushing screws and could be adjusted during foam extrusion experiments; decreasing the gap height would increase the die pressure. The gap could be increased and decreased as needed to identify the required operating pressure. Examples 4, 5, and 6 were conducted during the same extrusion run to isolate the effects of adding TDCE from expected run-to-run operating differences. The extruder was operated at 51b/hr of a general purpose polystyrene resin and 0.336 lb/hr of HFC-134a. Extrusion parameters, such as barrel temperature and screw speed, were set appropriate for foaming and the system was operated until steady-state was reached, at which point the required operating pressure was determined for Comparative Example 4. TDCE was then fed continuously using a dual-piston HPLC pump at 0.036 lb/hr until steady-state was reached and the required operating pressure determined for Example 5. The TDCE feed rate was then increased to 0.066 lb/hr until steady-state was reached and the required operating pressure determined for Example 6. The results are shown in Table 1, which gives the feed rates, the % TDCE in the blowing agent (B.A.), and ΔP, the drop in the required operating pressures, measured at the gear pump's discharge prior to the die, when using TDCE with 134a from the required operating pressure when using 134a alone. The effect of TDCE on the processability is apparent as evidenced by a drop in the required operating pressure.

TABLE 1

| | Feed rates (lb/hr) | | | % TDCE in | ΔP |
|---|---|---|---|---|---|
| Example | PS | HFC-134a | TDCE | B.A. | (psig) |
| 4 | 5 | 0.336 | 0 | 0% | — |
| 5 | 5 | 0.336 | 0.036 | 9.7% | 200 |
| 6 | 5 | 0.336 | 0.066 | 16.4% | 300 |

### Example 7

The extruder was setup according to Examples 4-6. The feed rates were 10.0 lb/hr of polystyrene pellets, 0.672 lb/hr of HFC-134a, and 0.066 lb/hr TDCE. The melt temperature of the expandable resin composition was adjusted to optimize foam properties in terms of density (or expansion ratio) and open cell content. The density of foam samples was measured according to ASTM D792 and open cell content was measured using gas pychnometry according to ASTM D285-C. Foamed products were produced with densities of approximately 3.1 pcf with open-cell contents approximately 25% or less, and with densities of approximately 3.4 pcf with open-cell contents approximately 15%. Reducing the resin melt temperature further would reduce the open cell content but with an increase in foam density.

It was found that because TDCE is a good solvent for polystyrene, too high a level of TDCE in the blowing agent blend might make it difficult to produce low density, closed-cell foam. It is believed that reduction in blowing power is too great and softening or dissolving of the walls of the foam cells results, leading to higher open cell content. It was found that the concentration of TDCE in the blowing agent composition would therefore preferably be less than about 25 wt % when producing closed-cell thermoplastic foam.

### Comparative Examples 8, 9 and 10

The extruder was setup according to examples 1 and 2. Foam samples collected during extrusion runs are rod-like samples with a diameter of less than one inch and were subsequently analyzed for foam density according to ASTM D792. Open cell content is determined according to a modified ASTM 2856-C, and cell size by manually measuring the lengths of foam cells from SEM micrographs of foam cross-sections.

HFC-134a (1,1,1,2-tetrafluoroethane) was used as the physical blowing agent of polystyrene resin. The Comparative Examples 8, 9 and 10 are shown in Table 2.

In Comparative Example 8 the foamable resin composition contained 5.74 wt % blowing agent (BA) at a melt temperature of 112° C. and produced a closed cell foam (OCC<10%) with a density of 4.4 pcf. The HFC-134a feed rate was then increased to 8.36 wt % and the melt temperature decreased to 108° C. The resulting foamed product had a density of 3.1 pcf with an OCC>80%. However, the increased blowing agent content also leads to foam defects including blow holes, voids, and skin defects.

Comparative Examples 10 shows that a higher density foamed product produced without TDCE, with a density of 5.3 pcf, was essentially closed-cell even at a high melt temperature of 135° C.

TABLE 2

| | PS Feed Rate | | Melt Temp. | Density | OCC |
|---|---|---|---|---|---|
| Example | (lb/hr) | wt % BA | (° C.) | (pcf) | (%) |
| 8 | 5.0 | 5.74 | 112 | 4.4 | <10% |
| 9 | 5.0 | 8.36 | 108 | 3.1 | >80% |
| 10 | 10.0 | 5.56 | 135 | 5.3 | <10% |

### Examples 11-15

A blowing agent blend was produced by mixing HFC-134a with TDCE at a ratio of 3:1 to give a final composition with 25 wt % TDCE.

The extrusion trial for Examples 11-15 started using pure HFC-134a as the blowing agent (BA) at a feed rate of 0.290 lb/hr, resulting in a foamable resin composition with 5.5 wt % HFC-134a to yield Comparative Example 11.

The blowing agent was then changed during the trial to the blend of HFC-134a with 25 wt % TDCE at a feed rate of 0.217 lb/hr. Example 12 was taken before the extrusion system had reestablished steady-state operation following the change in blowing agent and therefore contained an intermediate blowing agent composition between Comparative Example 11 and Example 13, providing a foamable resin composition where the blowing agent composition had <25 wt % TDCE. Example 1 was a relatively high density foam, 7.1 pcf, with an intermediate OCC of ˜30%.

Example 13 was taken at steady-state conditions were the blowing agent content was 4.2 wt % in the foamable resin composition. The foam product of Example 13 had an even higher density, 10.8 pcf, with an intermediate OCC of 25%.

The blowing agent feed rate was then increased to 0.503 lb/hr, which at steady-state would provide a foamable resin composition with 9.2 wt % blowing agent. Example 14 is a foam sample taken before steady-state was reestablished. The blowing agent composition was still 134a with 25 wt % TDCE but at an intermediate loading between 4.2 and 9.2 wt %. Example 14 is a low density foam, density of 3.5 pcf, with a high OCC of >60%.

At steady-state conditions, Example 15, the foam showed significant collapse so no foam property data are shown. For Example 15 the loading of blowing agent was too high for the operating temperature.

TABLE 3

| Exam- | PS Feed | wt % BA | | Melt Temp. | Density | OCC |
|---|---|---|---|---|---|---|
| ple | (lb/hr) | 134a | TDCE | (° C.) | (pcf) | (%) |
| 11 | 5.0 | 5.5 | — | 111 | 3.8 | ~20% |
| 12 | 5.0 | 5.5-3.2 | 0-1.04 | 115 | 7.1 | ~30% |
| 13 | 5.0 | 3.2 | 1.04 | 118 | 10.8 | ~25% |
| 14 | 5.0 | 3.2-6.7 | 1.0-2.3 | 114 | 3.5 | >60% |
| 15 | 5.0 | 6.7 | 2.3 | 114 | collapse | collapse |

### Examples 16-20

The extruder was setup according examples 4-6.

Polystyrene pellets were fed at a rate of 10.01b/hr. HFC-134a and TDCE were injected separately into the polymer melt at 0.672 lb/hr and 0.066 lb/hr respectively. This resulted in a blowing agent composition with 8.9 wt % TDCE in HFC-134a.

The extrusion temperature was progressively lowered to yield a melt temperature of 132° C. for Example 9 to 118° C. for Example 12. The results that TDCE permitted a production of intermediate to high open cell content foam products across a wide range of resin melt temperatures. Using the adjustable-lip slot die permitted production of foamed product with a lower density than achieved while using the 2 mm strand die. One skilled in the art will recognize that adjustments and changes in the foaming process can change the minimum density achievable for the foamed product.

TABLE 4
XPS foams with 134a/TDCE

| | Melt Temp. | Density | |
|---|---|---|---|
| Example | (° C.) | (pcf) | OCC (%) |
| 16 | 132 | 4.4 | ~20% |
| 17 | 127 | 3.1 | ~60% |
| 18 | 124 | 2.8 | ~50% |
| 19 | 120 | 3.0 | ~30% |
| 20 | 118 | 3.3 | ~20% |

### Examples 21-23

The extruder was setup as in examples 1-3. Two blowing agent blends were prepared with HFC-134a and TDCE, one with 10 wt % TDCE and the other with 5 wt % TDCE. Resulting foamed products using these blowing agents were analyzed for density, open cell content, and cell size from SEM micrographs of foam sections. The results are summarized in Table 5.

| | Blowing | | | | | | |
|---|---|---|---|---|---|---|---|
| | Agent | Blowing Agent | | Melt | Den- | | Cell |
| Exam- | Loading | Composition | | Temp. | sity | OCC | Size |
| ple | (wt %) | 134a | TDCE | (° C.) | (pcf) | (%) | (μm) |
| 21 | 9.3% | 90 wt % | 10 wt % | 136 | 3.7 | ~20% | 60-150 |
| 22 | 7.4% | 90 wt % | 10 wt % | 124 | 4.0 | ~40% | 25-35 |
| 23 | 7.3% | 95 wt % | 5 wt % | 124 | 5.6 | ~10% | 50-90 |

The examples demonstrate that use of TDCE in blowing agent compositions used in the production of thermoplastic foamed product can produce foamed products with higher open cell content. TDCE permits production of open cell thermoplastic foam at a higher densities than normally produced, resulting in higher compression strength, and open cell foams of greater cross section since the resin can be extruded at a lower temperature than normally done in producing open cell foam, limiting the problem of foam collapse.

While the embodiments of this invention have been shown with regard to specific details, as those skilled in the art recognize that the embodiments of this invention can still be practiced with modifications within the scope and spirit of the appended claims, including, but not limited to changes in equipment, the foaming process, manufacturing process, or materials.

Having described the invention, we now claim the following and their equivalents:

1. A thermoplastic foam blowing agent composition comprising trans-1,2-dichloroethylene and at least one other blowing agent.

2. The thermoplastic foam blowing agent composition of claim 1 wherein said other blowing agent is a fluorinated blowing agent.

3. The thermoplastic foam blowing agent composition of claim 2 wherein said fluorinated blowing agent contains a hydrofluorocarbon.

4. The thermoplastic foam blowing agent composition of claim 1 wherein said trans-1,2-dichloroethylene comprises about 25 weight % or less of said composition.

5. The thermoplastic foam blowing agent composition of claim 1 wherein said trans-1,2-dichloroethylene comprises about 10 weight % or less of said composition.

6. The thermoplastic foam blowing agent composition of claim 3 wherein said hydrofluorocarbon is selected from 1,1,1,2-tetrafluoroethane, 1,1,2,2-tetrafluoroethane, pentafluoroethane, 1,1,2-trifluoroethane, 1,1,1-trifluoroethane, 1,1,1,2,3,3,3-heptafluoropropane, difluoromethane, 1,1-difluoroethane or mixtures thereof.

7. The thermoplastic foam blowing agent composition of claim 1 further comprising carbon dioxide.

8. The thermoplastic foam blowing agent composition of claim 1 further comprising a hydrocarbon.

9. A rigid polystyrene foam composition comprising the foam blowing agent composition of claim 1.

10. The rigid polystyrene foam composition of claim 9 wherein said rigid polystyrene foam is a closed cell foam.

11. The rigid polystyrene foam composition of claim 10 wherein said rigid polystyrene foam has an open cell content of about 20% or less.

12. The rigid polystyrene foam composition of claim 10 wherein said rigid polystyrene foam has an open cell content of about 15% or less.

13. The rigid polystyrene foam composition of claim 10 wherein said rigid polystyrene foam has an open cell content of about 10% or less.

14. The rigid polystyrene foam composition of claim 9 wherein said rigid polystyrene foam is an open cell foam.

15. The rigid polystyrene foam composition of claim 14 wherein said rigid polystyrene foam has an open cell content of about 20% or more.

16. The rigid polystyrene foam composition of claim 14 wherein said rigid polystyrene foam has an open cell content of about 50% or more.

17. The rigid polystyrene foam composition of claim 14 wherein said rigid polystyrene foam has an open cell content of about 60% or more.

18. The rigid polystyrene foam composition of claim 14 wherein said rigid polystyrene foam has an open cell content of about 70% or more.
